(19) United States
(12) Patent Application Publication
(10) Pub. No.: US 2026/0046094 A1
(43) Pub. Date: Feb. 12, 2026

(54) ENHANCED CSI CONFIGURATION FOR SPATIAL DOMAIN ADAPTATION

(71) Applicant: Nokia Technologies Oy, Espoo (FI)

(72) Inventors: Daniela LASELVA, Aalborg (DK); Amol DHERE, Aalborg (DK); Matha DEGHEL, Massy (FR); Naizheng ZHENG, Beijing (CN)

(21) Appl. No.: 19/105,159

(22) PCT Filed: Sep. 29, 2022
(86) PCT No.: PCT/CN2022/122566

§ 371 Date: Feb. 20, 2025

(51) Int. Cl. H04L 5/00; H04W 72/23

(52) U.S. Cl. CPC H04L 5/0053; H04W 72/23

(57) ABSTRACT

An apparatus configured to: receive at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource: determine to use one of the at least two resource set configurations; and receive at least one reference signal based, at least partially, on the determined configuration of the at least two resource set configurations.

### TECHNICAL FIELD

The example and non-limiting embodiments relate generally to network energy savings and, more particularly, to component shutdown for energy savings.

### BACKGROUND

It is known, in radio access network technology, to enable base station power saving by turning off components.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: receive at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource; determine to use one of the at least two resource set configurations; and receive at least one reference signal based, at least partially, on the determined configuration of the at least two resource set configurations.

In accordance with one aspect, a method comprising: receiving, with a user equipment, at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource; determining to use one of the at least two resource set configurations; and receiving at least t one reference signal based, at least partially, on the determined configuration of the at least two resource set configurations.

In accordance with one aspect, an apparatus comprising means for performing: receiving at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource; determining to use one of the at least two resource set configurations; and receiving at least one reference signal based, at least partially, on the determined configuration of the at least two resource set configurations.

In accordance with one aspect, a non-transitory computer-readable medium comprising program instructions stored thereon for performing at least the following: receiving at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource; determining to use one of the at least two resource set configurations; and receiving at least one reference signal based, at least partially, on the determined configuration of the at least two resource set configurations.

In accordance with one aspect, an apparatus comprising: at least one processor; and at least one memory storing instructions that, when executed by the at least one processor, cause the apparatus at least to: transmit, to at least one user equipment, at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource; transmit, to the at least one user equipment, an indication to activate one of the at least two resource set configurations; and transmit, to the at least one user equipment, at least one reference signal based, at least partially, on the indicated configuration of the at least two resource set configurations.

In accordance with one aspect, a method comprising: transmitting, to at least one user equipment, at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource; transmitting, to the at least one user equipment, an indication to activate one of the at least two resource set configurations; and transmitting, to the at least one user equipment, at least one reference signal based, at least partially, on the indicated configuration of the at least two resource set configurations.

In accordance with one aspect, an apparatus comprising means for performing: transmitting, to at least one user equipment, at least two resource set configurations, wherein a first configuration of at the least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource; transmitting, to the at least one user equipment, an indication to activate one of the at least two resource set configurations; and transmitting, to the at least one user equipment, at least one reference signal based, at least partially, on the indicated configuration of the at least two resource set configurations.

In accordance with one aspect, a non-transitory computer-readable medium comprising program instructions stored thereon for performing at least the following: transmitting, to at least one user equipment, at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource; transmitting, to the at least one user equipment, an indication to activate one of the at least two resource set configurations; and transmitting, to the at least one user equipment, at least one reference signal based, at least partially, on the indicated configuration of the at least two resource set configurations.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a graph illustrating features as described herein;

FIG. 3 is a diagram illustrating features as described herein;

FIG. 4 is a flowchart illustrating steps as described herein;

FIG. 5 is a diagram illustrating features as described herein;

FIG. 6 is a diagram illustrating features as described herein;

FIG. 7 is a flowchart illustrating steps as described herein; and

FIG. 8 is a flowchart illustrating steps as described herein.

### DETAILED DESCRIPTION OF EMBODIMENTS

The following abbreviations that may be found in the specification and/or the drawing figures are defined as follows:

| | |
|---|---|
| 3GPP | third generation partnership project |
| 5G | fifth generation |
| 5GC | 5G core network |
| AMF | access and mobility management function |
| BS | base station |
| BWP | bandwidth part |
| CE | control element |
| CQI | channel quality indicator |
| cRAN | cloud radio access network |
| CSI | channel state information |
| CSI-IM | channel state information for interference measurement |
| CSI-RS | channel state information reference signal |
| CU | central unit |
| DCI | downlink control information |
| DL-SCH | downlink shared channel |
| DRB | data radio bearer |
| DTX | discontinuous reception |
| DU | distributed unit |
| eNB (or eNodeB) | evolved Node B (e.g., an LTE base station) |
| EN-DC | E-UTRA-NR dual connectivity |
| en-gNB or En-gNB | node providing NR user plane and control plane protocol |
| | terminations towards the UE, and acting as secondary node in EN- |
| | DC |
| EPRE | energy per resource element |
| E-UTRA | evolved universal terrestrial radio access, i.e., the LTE radio access |
| | technology |
| gNB (or gNodeB) | base station for 5G/NR, i.e., a node providing NR user plane and |
| | control plane protocol terminations towards the UE, and connected via |
| | the NG interface to the 5GC |
| I/F | interface |
| L1 | layer 1 |
| LTE | long term evolution |
| MAC | medium access control |
| MCS | modulation and coding scheme |
| MME | mobility management entity |
| MMSE-IRC | Minimum mean square error - interference rejection combining |
| ng or NG | new generation |
| ng-eNB or NG-eNB | new generation eNB |
| NR | new radio |
| NSA | non-stand-alone |
| N/W or NW | network |
| NZP-CSI-RS | non-zero power channel state information reference signal |
| OFDM | orthogonal frequency division multiplexing |
| O-RAN | open radio access network |
| PA | power amplifier |
| PCI | physical cell ID |
| PDCP | packet data convergence protocol |
| PDSCH | physical downlink shared channel |
| PHY | physical layer |
| PL-RS | pathloss reference signal |
| PUSCH | physical uplink shared channel |
| QoS | quality of service |
| RA | random access |
| RAN | radio access network |
| RF | radio frequency |
| RI | rank indicator |
| RLC | radio link control |
| RRC | radio resource control |
| RRH | remote radio head |
| RS | reference signal |
| RSRP | reference signal receive power |
| RSRQ | reference signal receive quality |
| RU | radio unit |
| Rx | receiver |
| SDAP | service data adaptation protocol |
| SGW | serving gateway |
| SI | system information |
| SIB | system information block |
| SINR | signal to interference noise ratio |
| SMF | session management function |
| SR | scheduling request |
| SRS | sounding reference signal |
| SS | synchronization signal |
| SSB | synchronization signal block |
| TCI | transmission configuration indicator |
| TRS | total radiated sensitivity |
| TRxP | transmission reception point |
| Tx or TX | transmitter/transceiver |
| TXRU or TxRU | transmitter/transceiver radio unit |
| UE | user equipment (e.g., a wireless, typically mobile device) |
| UPF | user plane function |
| VNR | virtualized network function |
| ZP-CSI-RS | zero power channel state information reference signal |
| μDTX | micro discontinuous transmission |

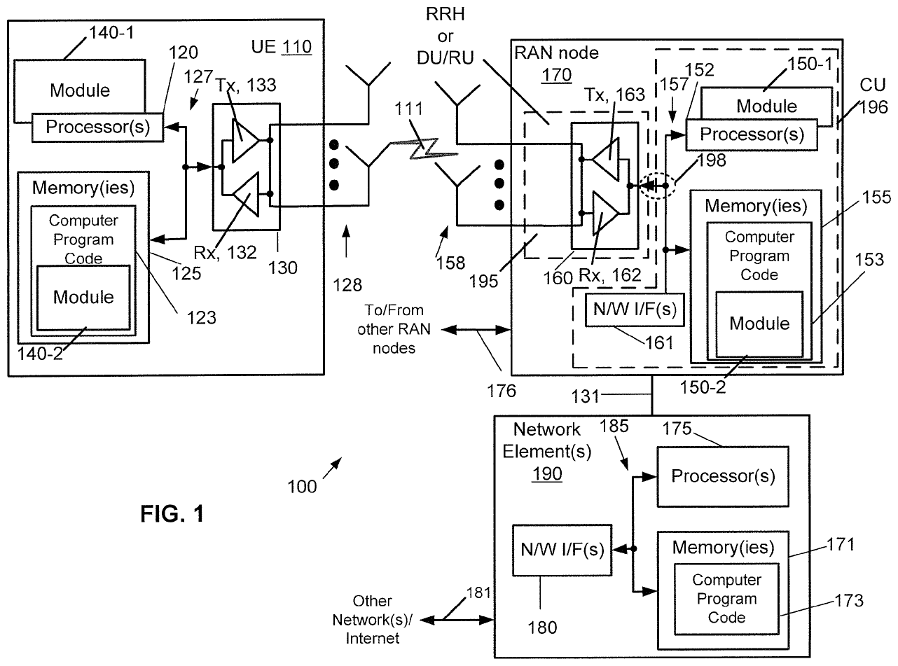

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the qNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or that terminals incorporate combinations of such functions.

Having thus introduced one suitable but non-limiting technical context for the practice of the example embodiments of the present disclosure, example embodiments will now be described with greater specificity.

Features described herein generally relate to network energy savings, for example in the radio access network, which consumes the largest part of the total energy consumption in the network. In 3GPP Rel. 18, RP-213554 aims at identifying adaptation techniques of transmissions and/or receptions in time, frequency, spatial, and power domains, with potential support/feedback from UE, potential UE assistance information, and information exchange/coordination over network interfaces. The current RAN1 #109 agreements from May 2022 on Rel. 18 NW ES study relate to the scope of study and can be found in the summary section of R1-2205554 “FL summary 109-e-Netw Energy NR-03 v091 moderator”.

NW energy saving may be achieved, for example, with infrequent synchronization signal block (SSB) transmission. For example, using SSB periodicity of 160 ms may be considered in empty/low load situation 5G in non-stand-alone (NSA) deployments.

NW energy saving may be achieved, for example, with a discontinuous transmission (DTX) technique. For example, radio units (e.g., power amplifier (PA)) may be switched on/off when there is no transmission to be made. Along with hardware and software capability improvement, the shutdown of the PA on an orthogonal frequency division multiplexing (OFDM) symbol basis may become possible and may commonly be applied in commercial networks. This is referred to as micro DTX (μDTX).

NW energy saving may be achieved, for example, with complete cell switch OFF (i.e., cell shutdown), which may allow switching off most of the hardware components of a cell, a frequency layer, or a RAN site.

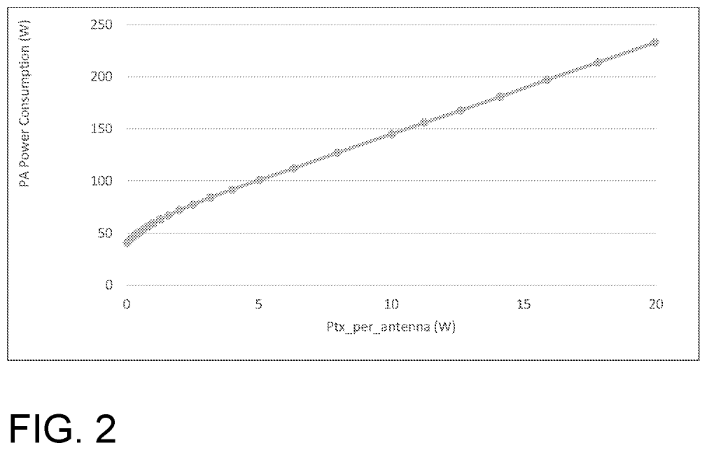

NW energy saving may be achieved, for example, with shutdown of further components, such as transmit antenna elements and corresponding baseband circuitry. Adjustments of the number of active TRXs and Tx power of the cell may be used as potential ways for base station power saving. For example, the number of active TRX chains may be reduced in low load conditions and depending on the UE location in the cell (e.g. cell edge vs cell center). Similarly, the transmit power level may be adjusted dynamically to make use of the transmission capacity and minimize the power amplifier power consumption (and in turn the total power consumption) when operating at lower Tx power levels, as shown in FIG. 2. Referring now to FIG. 2, illustrated is an example of power amplifier power consumption (y-axis) as a function of transmit power per active antenna for two physical Tx antennas (x-axis). One or more physical antennas may be mapped to one or more logical antenna ports. For example, two logical antenna ports may be mapped to one physical antenna port. For example, a single logical antenna port may be mapped to multiple physical antenna ports. It may be noted that, in the example of FIG. 2, PA power consumption increases as transmit power per active antenna increases. From the NW power saving perspective, the NW may consider reducing the number of utilized active antennas at empty/low-load in order to achieve NW power savings.

It may be noted that logical antenna ports correspond to specific reference signals; these reference signals may be used by a UE to derive channel-state information related to the logical antenna port. An example of a reference signal that corresponds to a logical antenna port may be a channel state information reference signals (CSI-RS).

Features as described herein may relate to CSI-RS. CSI-RS may be used for various purposes in NR. For example, they may be used for DL CSI acquisition. They may also be used to derive measurements for mobility and beam management, as well as for interference measurements. Currently, in NR, a UE may be configured with one or several CSI-RS resource-set, where each CSI-RS resource-set may include one or several configured CSI-RS resource(s) or SSB-block resource(s).

A CSI-RS resource-set may be operated as periodic, semi-persistent, or aperiodic. A CSI-RS resource may be configured with up to 32 logical antenna ports, and the density may be configurable. In the time domain, a CSI-RS resource may start at any OFDM symbol of a slot, and it may span 1, 2, or 4 OFDM symbols, depending on the number of ports configured. Likewise, the UE measurement reporting of CSI may also be operated in a periodic, semi-persistent, or aperiodic manner, which are the so-called report types in NR report configuration. However, there may be certain limitations, based on which the UE periodic report may only operate based on the configured periodic CSI-RS resource-set. The UE semi-persistent report may operate based on both configured periodic and semi-persistent CSI-RS resource-set. The UE aperiodic report may operate based on periodic, semi-persistent, and aperiodic CSI-RS resource-sets. In summary, the periodic CSI-RS resources may be used to generate any report type; the semi-persistent and periodic CSI-RS resources may be used to generate semi-persistent CSI reports; and the aperiodic CSI-RS may only be utilized to generate the aperiodic report.

In NR, as noted above, the configuration related to the CSI-RS transmission may comprise a list of CSI-RS resource-sets (see CSI-ResourceConfig in TS 38.331), where each set may include certain CSI-RS resources. For semi-persistent and aperiodic CSI-RS, the actual triggering of CSI-RS transmission may be per CSI-RS resource-set, via either medium access control (MAC) control element (CE) or downlink control information (DCI).

A resource set may be used as part of UE report configuration(s) describing what is to be measured and, correspondingly, which measurement reporting is to be done by the UE. Specifically, if a CSI-RS resource-set is configured as ‘aperiodic’ by radio resource control (RRC) signaling, the CSI-RS resource set configuration may include a slot offset, aperiodicTriggeringOffset, which defines the t interval between the triggering DCI and the CSI-RS transmission. When aperiodic CSI-RS is triggered, the gNB may be expected to send CSI-RS according to the slot offset defined by the RRC signaling, and the UE may expect to receive the CSI-RS within the indicated slot.

Besides non-zero power channel state information reference signals (NZP-CSI-RSs), which may be used for procedures like channel measurement, beam management, beam measurement, and/or connected mode mobility, zero power channel state information reference signals (ZP-CSI-RSs) may also be configured. These may be empty resource elements (REs) that may be used for interference measurement. Empty REs may or may not be monitored by a UE in order to make interference measurements. These REs may not contain any transmission for the UE, but may contain transmission(s) for other UEs. These REs may puncture the physical downlink shared channel (PDSCH) so the UE does not expect to receive any DL data within them. In other words, ZP-CSI-RS may be used to configure a RE puncturing pattern for the PDSCH when some REs are allocated for other purposes.

TS 38.214 describes CSI-RS as follows:
“ . . . 5.2.2.3 Reference signal (CSI-RS)
5.2.2.3.1 NZP CSI-RS
The UE can be configured with one or more NZP CSI-RS resource set configuration(s) as indicated by the higher layer parameters CSI-ResourceConfig, and NZP-CSI-RS-ResourceSet. Each NZP CSI-RS resource set consists of K>=1 NZP CSI-RS resource(s).
The following parameters for which the UE shall assume non-zero transmission power for CSI-RS resource are configured via the higher layer parameter NZP-CSI-RS-Resource, CSI-ResourceConfig and NZP-CSI-RS-ResourceSet for each CSI-RS resource configuration:
   nzp-CSI-RS-ResourceId determines CSI-RS resource configuration identity
   . . .
   resourceMapping defines the number of ports, CDM-type, and OFDM symbol and subcarrier occupancy of the CSI-RS resource within a slot th
   nrofPorts in resourceMapping defines the number of CSI-RS ports, where the allowable values are given in Clause 7.4.1.5 of [4, TS 38.211].
. . .
   powerControlOffset: which is the assumed ratio of PDSCH EPRE to NZP CSI-RS EPRE when UE derives CSI feedback and takes values in the range of [−8, 15] dB with 1 dB step size. For COI calculation based on a pair of NZP CSI-RS resources, powerControlOffset of each NZP CSI-RS resource in the pair of NZP CSI-RS resources for channel measurement is the assumed ratio of EPRE when UE derives CSI feedback and takes values in the range of [−8, 15] dB with 1 dB step size.
   powerControlOffsetSS: which is the assumed ratio of NZP CSI-RS EPRE to SS/PBCH block EPRE.
. . .
   BWP-Id in CSI-ResourceConfig defines which bandwidth part the configured CSI-RS is located in.
. . .
All CSI-RS resources within one set are configured with same density and same nrofPorts, except for the NZP CSI-RS resources used for interference measurement.
5.2.2.4 Channel State Information-Interference Measurement (CSI-IM)
The UE can be configured with one or more CSI-IM resource set configuration(s) as indicated by the higher layer parameter CSI-IM-ResourceSet. Each CSI-IM resource set consists of K≥1 CSI-IM resource(s).
. . .
5.2.2.5 CSI reference resource definition
. . .
When deriving CSI feedback, the UE is not expected that a NZP CSI-RS resource for channel measurement overlaps with CSI-IM resource for interference measurement or NZP CSI-RS resource for interference measurement.
5.1.4.2 PDSCH resource mapping with RE level granularity
. . .
Within a BWP, the UE can be configured with one or more ZP CSI-RS resource set configuration(s) for aperiodic, semi-persistent and periodic time-domain behaviours (higher layer parameters aperiodic-ZP-CSI-RSResourceSetsToAddModList, sp-ZP-CSI-RS-ResourceSetsToAddModList and p-ZP-CSI-RS-ResourceSet respectively comprised in PDSCH-Config), with each ZP CSI-RS resource set consisting of at most 16 ZP CSI-RS resources (higher layer parameter ZP-CSI-RS-Resource) in numerology of the BWP. The REs indicated by pZP-CSI-RS-ResourceSet are declared as not available for PDSCH. The REs indicated by sp-ZP-CSI-RSResourceSetsToAddModList and aperiodic-ZP-CSI-RS-ResourceSetsToAddModList are declared as not available for PDSCH when their triggering and activation are applied, respectively . . . ”

While the present disclosure uses the term “ZP-CSI-RS,” this is not limiting; other names may be used, such as ‘enhanced ZP-CSI-RS’ or any other name used to refer to a resource that the UE is not required or expected to utilize/recognize, for example as CSI-RS. In other words, a ZP-CSI-RS resource may puncture another channel/signal (e.g. the PDSCH) or another channel/signal (e.g. the PDSCH) and ZP-CSI-RS may be multiplexed by rate matching. It may also be noted that, in the present disclosure, ZP-CSI-RS and CSI-IM may be used interchangeably; wherever one term is used, the other may also be used.

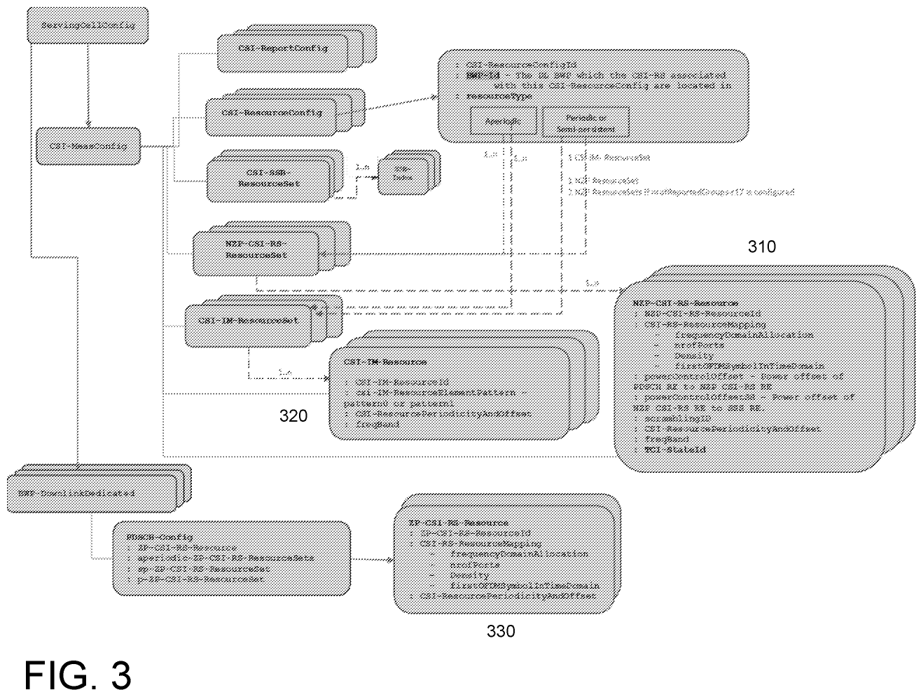

Referring now to FIG. 3, illustrated is an example of CSI-RS configuration, including NZP-CSI-RS (310), CSI-IM (320), and ZP-CSI-RS (330). It may be noted that each of the NZP-CSI-RS (310) and ZP-CSI-RS (330) allocations/descriptions include a CSI-RS-ResourceMapping attribute that includes an indication of a number of ports, nrofPorts.

As per R1-2205554, the following agreement was made at RAN1 #109 related to the techniques that will be studied as part of Study Item RP-213554 for the adaptations in spatial domain:
“ . . . . Further study techniques and enhancements for the adaptation of number of spatial elements of the gNB, including (but not limited to) the following aspects:
   Note: spatial elements may include antenna element(s), TxRU(s) (with sub-array/full-connection), antenna panel(s), TRxP(s) (co-located or geographically separated from each other), logical antenna port(s) (corresponding to specific signals and channels)
   impact to UE operations from dynamic adaptation of spatial elements, e.g. measurements, CSI feedback, power control, PUSCH/PDSCH repetition, SRS transmission, TCI configuration, beam management, beam failure recovery, radio link monitoring, cell (re) selection, handover, initial access, etc.,
   feedback/assistance information from the UE required for support dynamic spatial element adaptation
      for example, CSI measurement and reports, SR, etc
   signaling methods, including reduced signaling, for enabling dynamic spatial element adaptation
      for example, group-common L1 signaling, broadcast signaling, MAC CE, etc.
   dynamic TRxP adaptation;
      study of triggering on/off conditions for TRxP(s)
         note this may not have specification impact and could potentially be up to network implementation.
      study of SSB, PL-RS, TRS, and CSI-RS re-configuration and its impact to initial access procedure, synchronization and measurements performed by the idle/inactive/connected UE dynamic logical port adaptation and efficient port reconfigurations
      study details of signaling the port (e.g. NZP CSI-RS ports) (if required to be known by the UE)
      study dynamic adaptation (including activation/deactivation) of CSI measurement or report configuration for port adaptation
   Joint adaptation of spatial-domain, frequency-domain and/or power-domain configurations to avoid coverage loss . . . ”

Dynamically switching on/off antenna element(s) (e.g. TxRU(s) or entire TRxP) has an impact on the number of logical antenna ports the gNB supports/uses at a given time. This in turn means that certain CSI-RS (logical) ports (mapped to the shutdown physical antenna ports) need to be muted as well. It may be beneficial for the UE to receive signaling of information about which CSI-RS ports are muted or disabled, for example so as to avoid unpredictable UE behavior, but this may lead to high signaling overhead if the switching is dynamic (e.g. frequent). A technical effect of example embodiments of the present disclosure may be to more efficiently signal CSI-RS port re-configuration and/or scheduling.

In an example embodiment, a gNB may configure a UE with at least two CSI-RS resource set configurations (e.g. Config-Id 1 and 2), which may be associated with each other (i.e. corresponding to each other). In an example embodiment, each CSI-RS resource set configuration may comprise the same CSI-RS resources/REs (e.g. for a given UE's bandwidth part (BWP)), and may each comprise both NZP-CSI-RSs and ZP-CSI-RSs/CSI-IM RSs. In an example embodiment, each CSI-RS resource set configuration may differ, at least, in respect to the number of ports assigned to resources of NZP-CSI-RSs and of ZP-CSI-RSs/CSI-IM RSS.

In an example embodiment, at least one resource/RE associated to NZP-CSI-RSs in a first configuration having nrofPortsNZP (i.e. defining the number of NZP-CSI-RS ports), may be associated to ZP-CSI-RSs/CSI-IM RSS in a second configuration, having nrofPortsZP/IM (i.e. defining the number of ZP-CSI-RS ports or CSI-IM ports).

In an example embodiment, the muting of certain CSI-RSs ports (over which the network does not perform CSI-RS transmission after muting the corresponding logical antenna ports) may be conveyed to the UE by defining the muted ports as ZP-CSI-RS ports (or CSI-IM ports).

In the present disclosure, for simplicity and without loss of generality, it may be assumed that the muted ports are defined as ZP-CSI-RS ports. However, this is not limiting; the muted ports may be alternatively defined as CSI-IM ports.

In an example embodiment, the actual configuration that the UE uses may be indicated by the network using L1/L2 signaling (e.g. by sending a DCI or MAC CE pointing to the desired Config-Id). For example, when the network desires to mute some CSI-RSs ports, it may indicate that to the UE using L1/L2 signaling that switches the current configuration to be used to a configuration that includes ZP-CSI-RS ports (i.e. muted ports). Because of the association between the two configurations, these configurations may be seen as mutually exclusive, such that the activation of one configuration may trigger the deactivation of the associated configuration implicitly (i.e. without explicit signaling from the network). Additionally or alternatively, each configuration may be considered “active,” but one configuration may over-write the other configuration.

In an example embodiment, the at least two configurations may be associated with each other by, for example, adding the config-ID of one configuration into (e.g. a field of) the other configuration.

In an example embodiment, for unmuting the muted REs or ports, the network may either activate the corresponding NZP-CSI-RS or may deactivate the ZP-CSI-RS that led to muting of the REs/ports. In other words, deactivating (e.g. via MAC CE or DCI) the ZP-CSI-RS may be seen by the UE as unmuting the previously muted REs/ports (e.g. using that ZP-CSI-RS). Additionally or alternatively, each configuration may be considered “active,” but one configuration may over-write the other configuration that includes muted/disabled ports. In an example embodiment, the network may transmit, to the user equipment, an indication to activate a resource set configuration and/or an indication to deactivate a resource set configuration.

In an example embodiment, the UE may not assume that the “muted” REs (defined as ZP-CSI-RS-Resources) are “empty” resource elements (REs). Instead, those REs may be used by the network to transmit PDSCH (e.g. for carrying PDSCH payload). The network may indicate to the UE whether the “muted” REs/ports (e.g., defined as ZP-CSI-RS resources or ports) should be assumed empty or not (e.g. for PDSCH mapping and rate matching assumption purposes at the UE). This indication may be carried, for example, via the DCI or MAC CE activating the ZP-CSI-RS resources, either through a new field/bit or using some existing/reserved bit(s)/field(s). In an example embodiment, a UE may not assume that an NZP-CSI-RS resource of the device (e.g. base station) may not be mapped to a resource element corresponding to a configured ZP-CSI-RS resource. Instead, those NZP-CSI-RS REs may be assumed to be used for the PDSCH transmission of the device (e.g. base station). Additionally or alternatively, the ZP-CSI-RS configuration may contain information regarding whether the muted REs/ports should be assumed as “empty” or not. When the network activates/triggers this configuration for a UE, the UE may determine what the assumption is regarding the corresponding muted/disabled REs/ports (e.g., whether PDSCH is mapped or not on the corresponding resources). A UE may monitor REs from a muted/disabled logical antenna port for PDSCH only.

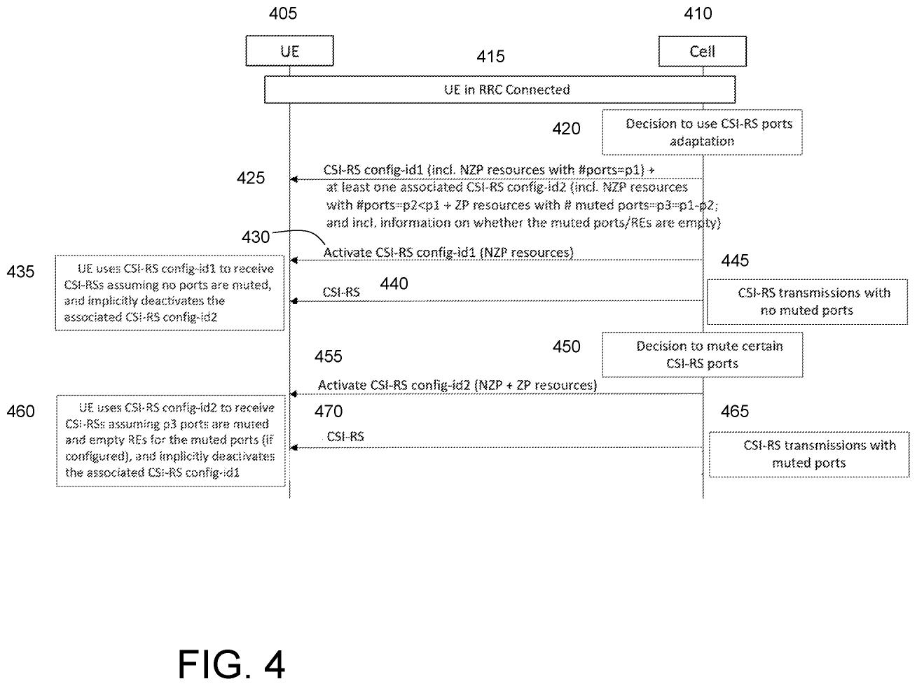

Referring now to FIG. 4, illustrated is a signaling diagram according to example embodiment(s) of the present disclosure. At 415, the UE (405) may be RRC connected to the cell (410), which may be, for example, a base station or gNB. At 420, the cell (410) may make the decision to use CSI-RS ports adaptation, for example according to an example embodiment of the present disclosure. At 425, the cell (410) may transmit, to the UE (405), at least two CSI-RS configurations, for example CSI-RS config-id1 and associated CSI-RS config-id2. For example, the UE (405) may be configured with one or more NZP CSI-RS resource set configuration(s). Each resource set configuration may consist of K>=1 NZP CSI-RS resource(s), where each NZP CSI-RS resource may be configured with a number of ports, nrofPorts. The same may be applicable to other resource types (e.g. ZP, CSI-IM, etc.).

Config-id 1 and Config-id 2 may include the same total number of RES (totREs=p1), occupying certain time and frequency resources. In this example, Config-id 1 may include all REs mapped only to NZP-CSI-RSs with a large (r) number of ports, defined as nrofPortsNZP1 (e.g. p1=32). Config-id 1 may be intended to be used when no CSI-RS port muting is used. In this example, Config-id 2 may include certain REs (out of the totREs) mapped to NZP-CSI-RSs associated with a smaller number of ports than in Config-id 1 (nrofPortsNZP2, e.g. p2=16), while the remaining REs may be mapped to ZP-CSI-RSs, and may be configured with the remaining number of (muted) ports (i.e. p3=number of muted ports=nrofPortsZP=nrofPortsNZP1-nrofPortsNZP2=p1−p2, e.g. 16). Config-id 2 may be intended to be used when a number of ports (nrofPortsNZP1-nrofPortsNZP2) are muted. Multiple configurations may be assigned to the UE with a different number of muted ports to allow flexibility in network operations.

At 430, the cell (410) may transmit, to the UE (405), signaling to activate CSI-RS config-id1 (NZP resources). In an example embodiment, the actual configuration that the UE is to use may be indicated by the network using L1/L2 signaling (e.g., a DCI or MAC CE), pointing to the desired configuration to be activated (having Config-id), which may be mutually exclusive with respect to the associated configuration that is deactivated implicitly by the UE.

L1/L2 signaling may comprise/be realized via DCI. In an example embodiment, a group-common DCI, common to multiple UEs in the cell, may be used for the purpose of switching the CSI-RS configuration id of multiple UEs at a time (like Format 2_1 OR Format 1_0 scrambled by SI-RNTI or another existing format or a new format). This may allow a more efficient signaling, for example in case multiple UEs are present in the cell.

In an example, the network may configure the pair (or trio or quartet, etc.) of configurations configured to indicate non-muting and muting of resources with the same identifiers for all UEs in the cell (e.g., non-muted with id1 and first muted with id2, second muted with id3, and so forth). In this way, the L1/L2 signaling may indicate, with a single configuration id, the same muting for all UEs.

In an example, the L1/L2 signaling may indicate an index pointing to which configuration in the pair/trio/quartet/etc. is to be activated, irrespective of the actual configuration identifiers assigned to the associated configurations. In the case of a pair of associated configurations, the network may indicate use of either the first or second configuration. In the case of a trio of associated configurations, the network may indicate use of the first, or second, or third configuration.

At 435, the UE (405) may use CSI-RS config-id1 to receive CSI-RSs. Based on CSI-RS config-id1, the UE (405) may assume that no ports are muted, and may implicitly deactivate the associated CSI-RS config-id2. For example, the UE (405) may receive one or more CSI-RS 440, which may be CSI-RS transmissions transmitted by the cell (410) based on the assumption of no muted ports (445).

At 450, the cell (410) may decide to mute certain CSI-RS ports. At 455, the cell (410) may transmit, to the UE (405), signaling to activate CSI-RS config-id2 (NZP+ZP resources). At 460, the UE (405) may use CSI-RS config-id2 to receive CSI-RSs, assuming p3 ports are muted, and may assume empty REs for the muted ports (if configured), and may implicitly deactivate the associated CSI-RS config-id1. For example, the UE (405) may receive one or more CSI-RS 470, which may be CSI-RS transmission transmitted by the cell (410) based on the assumption of muted ports (465).

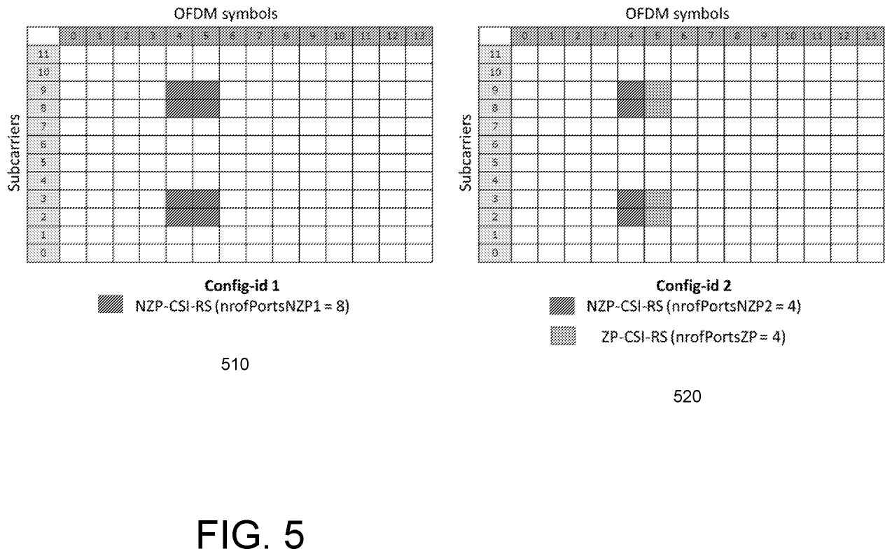

Referring now to FIG. 5, illustrated is an example of a cell with eight ports operating according to an example embodiment of the present disclosure, for example where the network has determined to configure a UE with two CSI-RS configurations that are associated with each other. Chart 510 illustrates an example of a first configuration, while chart 520 illustrates an example of a second configuration. In the first configuration, there may be no muting, which may be indicated to the UE with nrofPortsNZP1=8. In the second configuration, there may be muting, which may be indicated to the UE with nrofPortsNzp2=4 and nrofPortsZP=4. In other words, in the second configuration, four ports may be allocated to ZP-CSI-RS, and therefore may be regarded by the UE as being muted. Those four ports may have been designated as NZP-CSI-RS ports in the first configuration. In the example of FIG. 5, the 8-port configuration (corresponding to Row 7 in Table 7.4.1.5.3-1 of TS38.211) may be switched to the 4-port configuration (corresponding to Row 4 of the same table).

A technical effect of example embodiments of the present disclosure may be to enable use of a same resource as an NZP-CSI-RS-Resource (e.g. in the first configuration) and as a ZP-CSI-RS-Resource (e.g. in the second configuration) for the given UE but at different times. In an example embodiment, an overlapping resource may “implicitly” imply, for the UE, that such resource is muted in a configuration where such resource is defined as a ZP-CSI-RS-Resource, or as muted where such ZP-CSI-RS is activated.

In an example embodiment, the ZP-CSI-RS allocation for muting of NZP-CSI-RS may be provided under the configuration of “NZP-CSI-RS-ResourceSet”, or as part of an enhanced “NZP-CSI-RS-ResourceSet”. While the present disclosure generally refers to using ZP-CSI-RS to mute NZP-CSI-RS, ZP-CSI-RS may also be used to mute SSB. For example, if the ZP-CSI-RS is provided under the configuration of “CSI-SSB-ResourceSet,” the corresponding SSB may be muted. In a further alternative, it may be provided under the configuration of a new “ZP-CSI-RS-ResourceSet”.

In an example embodiment, the gNB may achieve micro DTX over one or more OFDM symbols where the ZP-CSI-RS ports are mapped. This may be achieved by assigning the NZP-CSI-RS ports in the same time-domain resources (OFDM symbol(s)) for multiple/all UEs, so that micro DTX may be used in these same OFDM symbol(s), where these UEs' NZP-CSI-RS ports are muted.

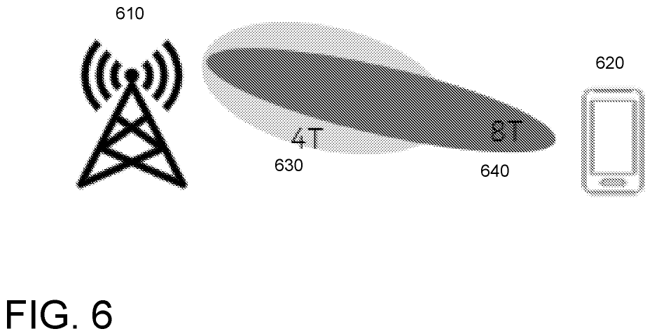

Another problem associated with switching off of TxRUs/antenna elements is the potential loss of coverage due to the reduced beamforming gain from the gNB Tx RUs/panels. A technical effect of example embodiments of the present disclosure may be to prevent coverage loss. In an example embodiment, neighboring gNBs may configure disjoint sets of NZP-CSI-RS to be muted (and so to be assigned as ZP-CSI-RS), which may have the technical effect of allowing their respective UEs to do DL interference measurements over the muted CSI-RSs. This may have the technical effect of allowing the UEs to do better DL interference measurements, and thereby compensate to some extent for the loss of beamforming gain. Referring now to FIG. 6, illustrated is an example of loss of beamforming gain when using muting of antenna ports. When transmitting with four antenna (630), the cell/base station (610) may experience beamforming gain loss in comparison to transmitting to a UE (620) with eight antenna (640). A technical effect of example embodiments of the present disclosure may be to compensate for loss of beamforming gain, for example by using signal-free interference measurements to calculate better co-variance or other statistics. This may have the technical effect of achieving better channel quality indicator (CQI) reporting and/or PDSCH demodulation using receivers doing interference rejection (e.g. MMSE-IRC).

In an alternative example embodiment, the network may configure the UE with at least one CSI-RS Resource Set configuration comprising NZP-CSI-RS resources and ports, and also including new information for at least one of the ports indicating that the at least one port can be potentially muted (i.e. the at least one port may be marked as “for muting” or “muting configured” or alike). The network may indicate (e.g. via L1/L2 signaling), to the UE, when the muting status is to be applied.

In an alternative example embodiment, the network may configure the UE with information about which ports will be muted (i.e. the ports marked as ZP-CSI-RS), and may indicate to the UE when the muting is to be performed (via L1/L2 signaling). This may have the technical effect of allowing the UE to omit receiving the CSI-RS resources mapped to any muted ports. In an alternative example embodiment, the network may configure the UE with information about which ports may be potentially muted (e.g. by marking these ports marked with a dynamic muting/potential ZP tag). However, the network may not send L1/L2 signaling with indication of the muted ports. Instead, the UE may monitor all the configured CSI-RS resources and perform a blind detection to determine whether any port marked for dynamic muting is currently active or not. Low false and low false positive detection(s) may be expected, at least for UEs located towards the cell center with high SINR, although this may have the technical effect of increasing the complexity and power consumption of the UE. The network may operate muting according to this variant, for example depending on the radio quality reported by the UE (e.g. SINR/RSRP/RSRQ/CQI). Additionally or alternatively, the network may use this variant when the “muting period” is much larger than the NZP-CSI-RS periodicity, for example Tmute>>TNZP-CSI-period. In this case, even the UEs with low SINR/RSRP may detect the muting using blind detection over multiple NZP-CSI-RS occasions. Furthermore, in this case, a static value for the minimum Tmute may be defined, after which the UE may need to again do blind detection of muting. This may be defined as either:
Tmute min as absolute value in milliseconds/seconds, or
Tmute min as N*TNZP-CSI-period, where N is an integer.

A technical effect of example embodiments of the present disclosure may be to leverage the ZP-CSI-RS/CSI-IM framework to dynamically perform antenna ports ON/OFF. In contrast with legacy configuration(s) of ZP-CSI-RS under the PDSCH-Config (or CSI-IM-ResourceSet), in example embodiment(s) of the present disclosure, the configuration of ZP-CSI-RS may be under (and associated to) the NZP-CSI-RS-ResourceSet configuration (or CSI-SSB-ResourceSet).

A technical effect of example embodiments of the present disclosure may be to enable partial recovery from loss of coverage due to reduced number of antennas/TxRUs by repurposing muted NZP-CSI-RS to CSI-IM resources and coordinating this across neighbor cell(s).

A technical effect of example embodiments of the present disclosure may be to allow efficient signaling to indicate the muting of CSI-RS resources, including allowing the activation of the muting to multiple UEs simultaneously.

A technical effect of example embodiments of the present disclosure may be to reduce the required DL signaling overhead, as ZP-CSI-RS as well as port muting may be conveyed/triggered using the same message.

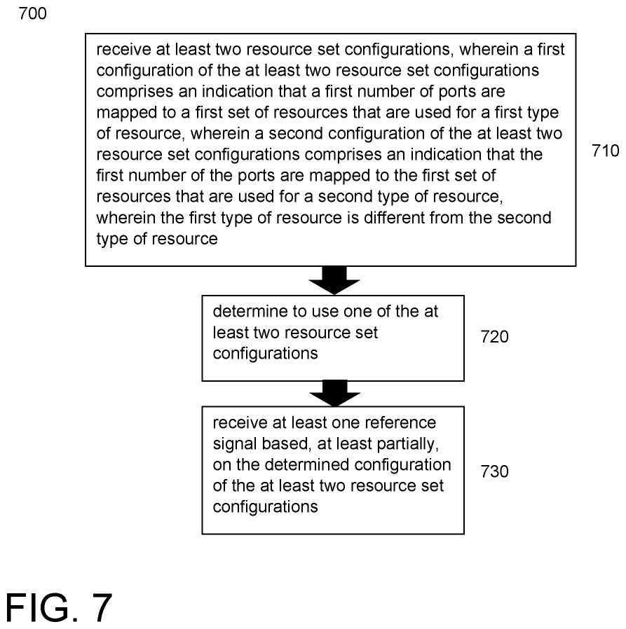

FIG. 7 illustrates the potential steps of an example method 600. The example method 700 may include: receiving at least two resource set configurations, wherein a first configuration of the at least two resource set configurations comprises an indication that a a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource, 710; determining to use one of the at least two resource set configurations, 720; and receiving at least one reference signal based, at least partially, on the determined configuration of the at least two resource set configurations, 730. The example method 700 may be performed, for example, with a user equipment. The second configuration may comprise an indication that a second number of the ports are mapped to a second set of resources that are used for the first type of resource. The first set of resource and the second set of resources may each comprise different resources.

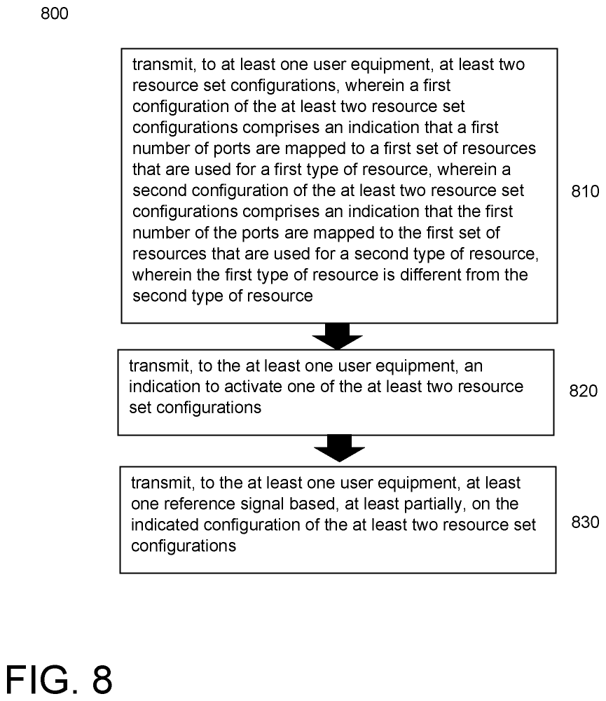

FIG. 8 illustrates the potential steps of an example method 800. The example method 800 may include: transmitting, to at least one user equipment, at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource, 810; transmitting, to the at least one user equipment, an indication to activate one of the at least two resource set configurations, 820; and transmitting, to the at least one user equipment, at least one reference signal based, at least partially, on the indicated configuration of the at least two resource set configurations, 830. The example method 800 may be performed, for example, with a cell, network node, base station, gNB, etc.

In accordance with one example embodiment, an apparatus may comprise: at least one processor; and at least one memory storing instructions that, when executed by the at least one processor, cause the apparatus at least to: receive at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; determine to use one of the at least two resource set configurations; and receive at least one reference signal based, at least partially, on the determined configuration of the at least two resource set configurations.

The first configuration may be associated with the second configuration, wherein the first configuration and the second configuration may be configured to be used in a mutually exclusive manner.

The first configuration may comprise, at least, an identifier of the second configuration, and wherein the second configuration may comprise, at least, an identifier of the first configuration.

Determining to use the one of the at least two resource set configurations may comprise the example apparatus being further configured to: perform blind detection of, at least, the first number of the ports to determine whether the first number of ports mapped to the first set of resources are used for the first type of resource or for the second type of resource; and determine to use the one of the at least two resource set configurations based on a result of the blind detection.

Determining to use the one of the at least two resource set configurations may comprise the example apparatus being further configured to: receive an indication to activate the one of the at least two resource set configurations.

The indication to activate the one of the at least two resource set configurations may be received via at least one of: L1 signaling, L2 signaling, a medium access control control element, a downlink control information, or signaling intended for a plurality of user equipments.

The indication to activate the one of the at least two resource set configurations may further comprise an indication that the second type of resource is not used to carry downlink information for the apparatus.

The indication to activate the one of the at least two resource set configurations may further comprise an indication that the second type of resource is used to carry downlink information for the apparatus.

The indication to activate the one of the at least two resource set configurations may comprise at least one of: an indication of an identifier of the one of the at least two resource set configurations to be activated, or an indication of an index of the one of the at least two resource set configurations to be activated.

The first type of resource may comprise a resource for carrying at least one of: downlink data for the apparatus, a non-zero power channel state information reference signal, a synchronization signal block, a signal for channel measurement, a signal for beam management, a signal for beam measurement, or a signal for connected mode mobility.

The second type of resource may comprise a resource for carrying at least one of: a zero-power channel state information reference signal, a channel state information for interference measurement, a signal for interference measurement, downlink data for an apparatus different from the apparatus, or a physical downlink shared channel payload.

The second configuration may comprise an indication that a second number of the ports are mapped to a second set of resources that are used for the first type of resource.

The example apparatus may be further configured to: deactivate at least one resource set configuration of the at least two resource set configurations, wherein the at least one resource set configuration may be different from the determined configuration of the at least two resource set configurations.

The example apparatus may be further configured to: receive the at least one reference signal from at least one of the first number of ports based on the first configuration in response to the first configuration being the determined configuration of the at least two resource set configurations.

The example apparatus may be further configured to: in response to the second configuration being the determined configuration of the at least two resource set configurations, one of: use the first set of resources mapped to the first number of ports for interference measurement, use the first set of resources mapped to the first number of ports to receive a data channel, or ignore the first set of resources mapped to the first number of ports.

In accordance with one aspect, an example method may be provided comprising: receiving, with a user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; determining to use one of the at least two resource set configurations; and receiving at least one reference signal based, at least partially, on the determined configuration of the at least two resource set configurations.

The first configuration may be associated with the second configuration, wherein the first configuration and the second configuration may be configured to be used in a mutually exclusive manner.

The first configuration may comprises, at least, an identifier of the second configuration, and wherein the second configuration may comprise, at least, an identifier of the first configuration.

Determining to use the one of the at least two resource set configurations may comprise: performing blind detection of, at least, the first number of the ports to determine whether the first number of ports mapped to the first set of resources are used for the first type of resource or for the second type of resource; and determining to use the one of the at least two resource set configurations based on a result of the blind detection.

Determining to use the one of the at least two resource set configurations may comprise: receiving an indication to activate the one of the at least two resource set configurations.

The indication to activate the one of the at least two resource set configurations may be received via at least one of: L1 signaling, L2 signaling, a medium access control control element, a downlink control information, or signaling intended for a plurality of user equipments.

The indication to activate the one of the at least two resource set configurations may further comprise an indication that the second type of resource is not used to carry downlink information for the user equipment.

The indication to activate the one of the at least two resource set configurations may further comprise an indication that the second type of resource is used to carry downlink information for the user equipment.

The indication to activate the one of the at least two resource set configurations may comprise at least one of: an indication of an identifier of the one of the at least two resource set configurations to be activated, or an indication of an index of the one of the at least two resource set configurations to be activated.

The first type of resource may comprise a resource for carrying at least one of: downlink data for the user equipment, a non-zero power channel state information reference signal, a synchronization signal block, a signal for channel measurement, a signal for beam management, a signal for beam measurement, or a signal for connected mode mobility.

The second type of resource may comprise a resource for carrying at least one of: a zero-power channel state information reference signal, a channel state information for interference measurement, a signal for interference measurement, downlink data for a user equipment different from the user equipment, or a physical downlink shared channel payload.

The second configuration may comprise an indication that a second number of the ports are mapped to a second set of resources that are used for the first type of resource.

The example method may further comprise: deactivating at least one resource set configuration of the at least two resource set configurations, wherein the at least one resource set configuration may be different from the determined configuration of the at least two resource set configurations.

The example method may further comprise: receiving the at least one reference signal from at least one of the first number of ports based on the first configuration in response to the first configuration being the determined configuration of the at least two resource set configurations.

The example method may further comprise: in response to the second configuration being the determined configuration of the at least two resource set configurations, one of: using the first set of resources mapped to the first number of ports for interference measurement, using the first set of resources mapped to the first number of ports to receive a data channel, or ignoring the first set of resources mapped to the first number of ports.

In accordance with one example embodiment, an apparatus may comprise: circuitry configured to perform: receiving, with a user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; circuitry configured to perform: determining to use one of the at least two resource set configurations; and circuitry configured to perform: receiving at least one reference signal based, at least partially, on the determined configuration of the at least two resource set configurations.

In accordance with one example embodiment, an apparatus may comprise: processing circuitry; memory circuitry including computer program code, the memory circuitry and the computer program code configured to, with processing circuitry, enable the apparatus to: receive at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; determine to use one of the at least two resource set configurations; and receive at least one reference signal based, at least partially, on the determined configuration of the at least two resource set configurations.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: receiving at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; determining to use one of the at least two resource set configurations; and receiving at least one reference signal based, at least partially, on the determined configuration of the at least two resource set configurations.

The first configuration may be associated with the second configuration, wherein the first configuration and the second configuration may be configured to be used in a mutually exclusive manner.

The first configuration may comprise, at least, an identifier of the second configuration, and wherein the second configuration may comprise, at least, an identifier of the first configuration.

The means configured to perform determining to use the one of the at least two resource set configurations may comprises means configured to perform: blind detection of, at least, the first number of the ports to determine whether the first number of ports mapped to the first set of resources are used for the first type of resource or for the second type of resource; and determining to use the one of the at least two resource set configurations based on a result of the blind detection.

The means configured to perform determining to use the one of the at least two resource set configurations may comprises means configured to perform: receiving an indication to activate the one of the at least two resource set configurations.

The indication to activate the one of the at least two resource set configurations may be received via at least one of: L1 signaling, L2 signaling, a medium access control control element, a downlink control information, or signaling intended for a plurality of user equipments.

The indication to activate the one of the at least two resource set configurations may further comprise an indication that the second type of resource is not used to carry downlink information for the apparatus.

The indication to activate the one of the at least two resource set configurations may further comprise an indication that the second type of resource is used to carry downlink information for the apparatus.

The indication to activate the one of the at least two resource set configurations may comprise at least one of: an indication of an identifier of the one of the at least two resource set configurations to be activated, or an indication of an index of the one of the at least two resource set configurations to be activated.

The first type of resource may comprise a resource for carrying at least one of: downlink data for the apparatus, a non-zero power channel state information reference signal, a synchronization signal block, a signal for channel measurement, a signal for beam management, a signal for beam measurement, or a signal for connected mode mobility.

The second type of resource may comprise a resource for carrying at least one of: a zero-power channel state information reference signal, a channel state information for interference measurement, a signal for interference measurement, downlink data for an apparatus different from the apparatus, or a physical downlink shared channel payload.

The second configuration may comprise an indication that a second number of the ports are mapped to a second set of resources that are used for the first type of resource.

The means may be further configured to perform: deactivating at least one resource set configuration of the at least two resource set configurations, wherein the at least one resource set configuration may be different from the determined configuration of the at least two resource set configurations.

The means may be further configured to perform: receiving the at least one reference signal from at least one of the first number of ports based on the first configuration in response to the first configuration being the determined configuration of the at least two resource set configurations.

The means may be further configured to perform: in response to the second configuration being the determined configuration of the at least two resource set configurations, one of: using the first set of resources mapped to the first number of ports for interference measurement, using the first set of resources mapped to the first number of ports to receive a data channel, or ignoring the first set of resources mapped to the first number of ports.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: receive at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; determine to use one of the at least two resource set configurations; and receive at least one reference signal based, at least partially, on the determined configuration of the at least two resource set configurations.

In accordance with one example embodiment, a non-transitory computer-readable medium comprising program instructions stored thereon for performing at least the following: receiving at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; determining to use one of the at least two resource set configurations; and receiving at least one reference signal based, at least partially, on the determined configuration of the at least two resource set configurations.

In accordance with another example embodiment, a non-transitory program storage device readable by a machine may be provided, tangibly embodying instructions executable by the machine for performing operations, the operations comprising: receiving at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; determining to use one of the at least two resource set configurations; and receiving at least one reference signal based, at least partially, on the determined configuration of the at least two resource set configurations.

In accordance with another example embodiment, a non-transitory computer-readable medium comprising instructions that, when executed by an apparatus, cause the apparatus to perform at following: least the receiving at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; determining to use one of the at least two resource set configurations; and receiving at least one reference signal based, at least partially, on the determined configuration of the at least two resource set configurations.

A computer implemented system comprising: at least one processor and at least one non-transitory memory storing instructions that, when executed by the at least one processor, cause the system at least to perform: receiving at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; determining to use one of the at least two resource set configurations; and receiving at least one reference signal based, least at partially, on the determined configuration of the at least two resource set configurations.

A computer implemented system comprising: means for receiving at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; means for determining to use one of the at least two resource set configurations; and means for receiving at least one reference signal based, at least partially, on the determined configuration of the at least two resource set configurations.

In accordance with one example embodiment, an apparatus may comprise: at least one processor; and at least one memory storing instructions that, when executed by the at least one processor, cause the apparatus at least to: transmit, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; transmit, to the at least one user equipment, an indication to activate one of the at least two resource set configurations; and transmit, to the at least one user equipment, at least one reference signal based, at least partially, on the indicated configuration of the at least two resource set configurations.

The first configuration may be associated with the second configuration, wherein the first configuration and the second configuration may be configured to be used in a mutually exclusive manner.

The first configuration may comprise, at least, an identifier of the second configuration, and wherein the second configuration may comprise, at least, an identifier of the first configuration.

The indication to activate the one of the at least two resource set configurations may be transmitted via at least one of: L1 signaling, L2 signaling, a medium access control control element, a downlink control information, or signaling intended for a plurality of user equipments.

The indication to activate the one of the at least two resource set configurations may further comprise an indication that the second type of resource is not used to carry downlink information for the at least one user equipment.

The indication to activate the one of the at least two resource set configurations may further comprise an indication that the second type of resource is used to carry downlink information for the at least one user equipment.

The indication to activate the one of the at least two resource set configurations may comprise at least one of: an indication of an identifier of the one of the at least two resource set configurations to be activated, or an indication of an index of the one of the at least two resource set configurations to be activated.

The first type of resource may comprise a resource for carrying at least one of: downlink data for the apparatus, a non-zero power channel state information reference signal, a synchronization signal block, a signal for channel measurement, a signal for beam management, a signal for beam measurement, or a signal for connected mode mobility.

The second type of resource may comprise a resource for carrying at least one of: a zero-power channel state information reference signal, a channel state information for interference measurement, a signal for interference measurement, downlink data for an apparatus different from the apparatus, or a physical downlink shared channel payload.

The second configuration may comprise an indication that a second number of the ports are mapped to a second set of resources that are used for the first type of resource.

In accordance with one aspect, an example method may be provided comprising: transmitting, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; transmitting, to the at least one user equipment, an indication to activate one of the at least two resource set configurations; and transmitting, to the at least one user equipment, at least one reference signal based, at least partially, on the indicated configuration of the at least two resource set configurations.

The first configuration may be associated with the second configuration, wherein the first configuration and the second configuration may be configured to be used in a mutually exclusive manner.

The first configuration may comprise, at least, an identifier of the second configuration, and wherein the second configuration may comprise, at least, an identifier of the first configuration.

The indication to activate the one of the at least two resource set configurations may be transmitted via at least one of: L1 signaling, L2 signaling, a medium access control control element, a downlink control information, or signaling intended for a plurality of user equipments.

The indication to activate the one of the at least two resource set configurations may further comprise an indication that the second type of resource is not used to carry downlink information for the at least one user equipment.

The indication to activate the one of the at least two resource set configurations may further comprise an indication that the second type of resource is used to carry downlink information for the at least one user equipment.

The indication to activate the one of the at least two resource set configurations may comprise at least one of: an indication of an identifier of the one of the at least two resource set configurations to be activated, or an indication of an index of the one of the at least two resource set configurations to be activated.

The first type of resource may comprise a resource for carrying at least one of: downlink data for the apparatus, a non-zero power channel state information reference signal, a synchronization signal block, a signal for channel measurement, a signal for beam management, a signal for beam measurement, or a signal for connected mode mobility.

The second type of resource may comprise a resource for carrying at least one of: a zero-power channel state information reference signal, a channel state information for interference measurement, a signal for interference measurement, downlink data for an apparatus different from the apparatus, or a physical downlink shared channel payload.

The second configuration may comprise an indication that a second number of the ports are mapped to a second set of resources that are used for the first type of resource.

In accordance with one example embodiment, an apparatus may comprise: circuitry configured to perform: transmitting, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; transmitting, to the at least one user equipment, an indication to activate one of the at least two resource set configurations; and circuitry configured to perform: transmitting, to the at least one user equipment, at least one reference signal based, at least partially, on the indicated configuration of the at least two resource set configurations.

In accordance with one example embodiment, an apparatus may comprise: processing circuitry; memory circuitry including computer program code, the memory circuitry and the computer program code configured to, with the processing circuitry, enable the apparatus to: transmit, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; transmit, to the at least one user equipment, an indication to activate one of the at least two resource set configurations; and transmit, to the at least one user equipment, at least one reference signal based, at least partially, on the indicated configuration of the at least two resource set configurations.

In accordance with one example embodiment, an apparatus may comprise means for performing: transmitting, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that first number of the ports are mapped to the first set of resources that are used for a second type of resource, wherein the first type of resource may be different from the second type of resource; transmitting, to the at least one user equipment, an indication to activate one of the at least two resource set configurations; and transmitting, to the at least one user equipment, at least one reference signal based, at least partially, on the indicated configuration of the at least two resource set configurations.

The first configuration may be associated with the second configuration, wherein the first configuration and the second configuration may be configured to be used in a mutually exclusive manner.

The first configuration may comprise, at least, an identifier of the second configuration, and wherein the second configuration may comprise, at least, an identifier of the first configuration.

The indication to activate the one of the at least two resource set configurations may be transmitted via at least one of: L1 signaling, L2 signaling, a medium access control control element, a downlink control information, or signaling intended for a plurality of user equipments.

The indication to activate the one of the at least two resource set configurations may further comprise an indication that the second type of resource is not used to carry downlink information for the at least one user equipment.

The indication to activate the one of the at least two resource set configurations may further comprise an indication that the second type of resource is used to carry downlink information for the at least one user equipment.

The indication to activate the one of the at least two resource set configurations may comprise at least one of: an indication of an identifier of the one of the at least two resource set configurations to be activated, or an indication of an index of the one of the at least two resource set configurations to be activated.

The first type of resource may comprise a resource for carrying at least one of: downlink data for the apparatus, a non-zero power channel state information reference signal, a synchronization signal block, a signal for channel measurement, a signal for beam management, a signal for beam measurement, or a signal for connected mode mobility.

The second type of resource may comprise a resource for carrying at least one of: a zero-power channel state information reference signal, a channel state information for interference measurement, a signal for interference measurement, downlink data for an apparatus different from the apparatus, or a physical downlink shared channel payload.

The second configuration may comprise an indication that a second number of the ports are mapped to a second set of resources that are used for the first type of resource.

In accordance with one example embodiment, a non-transitory computer-readable medium comprising instructions stored thereon which, when executed with at least one processor, cause the at least one processor to: transmit, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; transmitting, to the at least one user equipment, an indication to activate one of the at least two resource set configurations; and transmit, to the at least one user equipment, at least one reference signal based, at least partially, on the indicated configuration of the at least two resource set configurations.

In accordance with one example embodiment, a non-transitory computer-readable medium comprising program instructions stored thereon for performing at least the following: transmitting, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; transmitting, to the at least one user equipment, an indication to activate one of the at least two resource set configurations; and transmitting, to the at least one user equipment, at least one reference signal based, at least partially, on the indicated configuration of the at least two resource set configurations.

In accordance with another example embodiment, a non-transitory program storage device readable by a machine may be provided, tangibly embodying instructions executable by the machine for performing operations, the operations comprising: transmitting, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; transmitting, to the at least one user equipment, an indication to activate one of the at least two resource set configurations; and transmitting, to the at least one user equipment, at least one reference signal based, at least partially, on the indicated configuration of the at least two resource set configurations.

In accordance with another example embodiment, a non-transitory computer-readable medium comprising instructions that, when executed by an apparatus, cause the apparatus to perform at least the following: transmitting, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; transmitting, to the at least one user equipment, an indication to activate one of the at least two resource set configurations; and transmitting, to the at least one user equipment, at least one reference signal based, at least partially, on the indicated configuration of the at least two resource set configurations.

A computer implemented system comprising: at least one processor and at least one non-transitory memory storing instructions that, when executed by the at least one processor, cause the system at least to perform: transmitting, to at least one user equipment, at least two resource set configurations, wherein a first configuration of the at least two resource set configurations may comprise an indication that a first number of ports are mapped to a first set of resources that are used for a first type of resource, wherein a second configuration of the at: least two resource set configurations may comprise an indication that the first number of the ports are mapped to the first set of resources that are used for a second type of resource, wherein the first type of resource may be different from the second type of resource; transmitting, to the at least one user equipment, an indication to activate one of the at least two resource set configurations; and transmitting, to the at least one user equipment, at least one reference signal based, at least partially, on the indicated configuration of the at least two resource set configurations.

A computer implemented system comprising: means for transmitting, to at least one user equipment, at least two resource set configurations, wherein a first configuration of the at least two resource set configurations may comprise an indication that a first number of ports are mapped to a first set of resources that are used for a first type of resource, wherein a second configuration of the at least two resource set configurations may comprise an indication that the first number of the ports are mapped to the first set of resources that are used for a second type of resource, wherein the first type of resource may be different from the second type of resource; transmitting, to the at least one user equipment, an indication to activate one of the at least two resource set configurations; and means for transmitting, to the at least one user equipment, at least one reference signal based, at least partially, on the indicated configuration of the at least two resource set configurations.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1. An apparatus comprising:
at least one processor; and
at least one memory storing instructions that, when executed by the at least one processor, cause the apparatus at least to:
receive at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource;
determine to use one of the at least two resource set configurations; and
receive at least one reference signal based, at least partially, on the determined configuration of the at least two resource set configurations.

2. The apparatus of claim 1, wherein the first configuration is associated with the second configuration, wherein the first configuration and the second configuration are configured to be used in a mutually exclusive manner.

3. The apparatus of claim 1, wherein the first configuration comprises, at least, an identifier of the second configuration, and wherein the second configuration comprises, at least, an identifier of the first configuration.

4. The apparatus of claim 1, wherein determining to use the one of the at least two resource set configurations comprises the at least one memory, storing the instructions, when executed by the at least one processor, causes the apparatus to:
perform blind detection of, at least, the first number of the ports to determine whether the first number of ports mapped to the first set of resources are used for the first type of resource or for the second type of resource; and
determine to use the one of the at least two resource set configurations based on a result of the blind detection.

5. The apparatus of claim 1, wherein determining to use the one of the at least two resource set configurations comprises the at least one memory, storing the instructions, when executed by the at least one processor, causes the apparatus to:
receive an indication to activate the one of the at least two resource set configurations.

6. The apparatus of claim 5, wherein the indication to activate the one of the at least two resource set configurations is received via at least one of:
L1 signaling,
L2 signaling,
a medium access control control element,
a downlink control information, or
signaling intended for a plurality of user equipments.

7. The apparatus of claim 5, wherein the indication to activate the one of the at least two resource set configurations further comprises an indication that the second type of resource is not used to carry downlink information for the apparatus.

8. The apparatus of claim 5, wherein the indication to activate the one of the at least two resource set configurations further comprises an indication that the second type of resource is used to carry downlink information for the apparatus.

9. The apparatus of claim 5, wherein the indication to activate the one of the at least two resource set configurations comprises at least one of:
an indication of an identifier of the one of the at least two resource set configurations to be activated, or
an indication of an index of the one of the at least two resource set configurations to be activated.

10. The apparatus of claim 1, wherein the first type of resource comprises a resource for carrying at least one of:
downlink data for the apparatus,
a non-zero power channel state information reference signal,
a synchronization signal block,
a signal for channel measurement,
a signal for beam management,
a signal for beam measurement, or
a signal for connected mode mobility.

11. The apparatus of claim 1, wherein the second type of resource comprises a resource for carrying at least one of:
a zero-power channel state information reference signal,
a channel state information for interference measurement,
a signal for interference measurement,
downlink data for an apparatus different from the apparatus, or
a physical downlink shared channel payload.

12. The apparatus of claim 1, wherein the second configuration comprises an indication that a second number of the ports are mapped to a second set of resources that are used for the first type of resource.

13. The apparatus of claim 1, wherein the at least one memory, storing the instructions, when executed by the at least one processor, causes the apparatus to:
deactivate at least one resource set configuration of the at least two resource set configurations, wherein the at least one resource set configuration is different from the determined configuration of the at least two resource set configurations.

14. The apparatus of claim 1, wherein the at least one memory, storing the instructions, when executed by the at least one processor, causes the apparatus to:
receive the at least one reference signal from at least one of the first number of ports based on the first configuration in response to the first configuration being the determined configuration of the at least two resource set configurations.

15. The apparatus of claim 1, wherein the at least one memory, storing the instructions, when executed by the at least one processor, causes the apparatus to:
in response to the second configuration being the determined configuration of the at least two resource set configurations, one of:
use the first set of resources mapped to the first number of ports for interference measurement,
use the first set of resources mapped to the first number of ports to receive a data channel, or
ignore the first set of resources mapped to the first number of ports.

16. A method comprising:
receiving, with a user equipment, at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource;
determining to use one of the at least two resource set configurations; and
receiving at least one reference signal based, at least partially, on the determined configuration of the at least two resource set configurations.

17. The method of claim 16, wherein the first configuration is associated with the second configuration, wherein the first configuration and the second configuration are configured to be used in a mutually exclusive manner.

18. The method of claim 16, wherein the first configuration comprises, at least, an identifier of the second configuration, and wherein the second configuration comprises, at least, an identifier of the first configuration.

19. The method of claim 16, wherein determining to use the one of the at least two resource set configurations comprises:
performing blind detection of, at least, the first number of the ports to determine whether the first number of ports mapped to the first set of resources are used for the first type of resource or for the second type of resource; and
determining to use the one of the at least two resource set configurations based on a result of the blind detection.

20-31. (canceled)

32. An apparatus comprising:
at least one processor; and
at least one memory storing instructions that, when executed by the at least one processor, cause the apparatus at least to:
transmit, to at least one user equipment, at least two resource set configurations, wherein a first configuration of the at least two resource set configurations comprises an indication that a first number of ports are mapped to a first set of resources that are used for a first type of resource, wherein a second configuration of the at least two resource set configurations comprises an indication that the first number of the ports are mapped to the first set of resources that are used for a second type of resource, wherein the first type of resource is different from the second type of resource;
transmit, to the at least one user equipment, an indication to activate one of the at least two resource set configurations; and
transmit, to the at least one user equipment, at least one reference signal based, at least partially, on the indicated configuration of the at least two resource set configurations.

33-50. (canceled)
